(19) United States
(12) Patent Application Publication
(10) Pub. No.: US 2012/0031832 A1
(43) Pub. Date: Feb. 9, 2012

(54) CYLINDRICAL FILTER

(76) Inventors: Hiroaki Yamaguchi, Tokyo (JP); Satoshi Ishii, Kanagawa pref (JP); Moriyuki Komatsu, Ibaragi pref (JP)

(21) Appl. No.: 13/265,280

(22) PCT Filed: Apr. 21, 2010
(86) PCT No.: PCT/US2010/031844

§ 371 Date: Oct. 19, 2011

(30) Foreign Application Priority Data
Apr. 27, 2009 (JP) 2009-108241

(51) Int. Cl. B01D 39/14

(52) U.S. Cl. 210/450

(57) ABSTRACT

To improve particle capturing performance and classification filtering capacity of a cylindrical filter. A cylindrical filter includes a hollow cylindrical filter body configured by suitably combining a plurality of cylindrical first filter sections having mutually different inner diameters, each first filter section including a glass fiber as a major component, and a plurality of cylindrical second filter sections having mutually different inner diameters, each second filter section including a resin fiber as a major component, with each other. The first filter sections and the second filter sections are disposed in a concentrically superimposed manner and alternately arranged in a radial direction relative to each other. The cylindrical filter further includes a pair of seal members fixedly provided on the opposite axial ends of the first and second filter sections.

### TECHNICAL FIELD

The present invention relates to a cylindrical filter.

### BACKGROUND

In the field of a filtration systems for liquid or gas, a hollow cylindrical or tubular filter (hereinafter referred to as a cylindrical filter) is often used. The filter is configured by assembling a plurality of filter media having different filtering functions and associated with one another in a concentrically superimposed construction.

For example, Japanese Unexamined Patent Publication (Kokai) No. 55-024575 describes “a method of manufacturing a cartridge filter for precise filtration, characterized in that a fixed width fiber layer composed of heat-fusible composite fibers is preheated to a heat-fusible temperature and is wound onto a winding core to form a sheet-supporting layer. A porous sheet material having the same width as the fiber layer is wound around the fiber layer at least 1.5 times to form a precision filtration layer. Thereafter, the a second fiber layer is wound around the precision filtration layer to provide a pre-filtration layer. The winding core is then withdrawn.

Japanese Unexamined Patent Publication (Kokai) No. 09-122414, describes “a cylindrical filter” having similar configuration as the cartridge filter for precision filtration described in the foregoing Kokai 55-024575, in which “a glass fiber non-woven fabric layer” is the precision filtration layer.

The cylindrical filters described in the foregoing Japanese Kokai have a so-called coreless configuration wherein, because the required rigidity of the overall filter can be secured by heat-fusing or bonding the fiber aggregation layer, the winding core can be withdrawn out after shaping and cooling of the filter.

On the other hand, a so-called core-type cylindrical filter, i.e., a cylindrical filter which is configured by winding a general non-woven fabric filter media not containing heat-fusible composite fibers onto a core having a perforated cylindrical wall, has been also known.

For example, Japanese Unexamined Utility Model Publication (Kokai) No. 01-170417 describes “a non-woven fabric wound and laminated-type cartridge filter” which is configured by winding onto a perforated core a non-woven fabric together with a coarse net applied to one side of the non-woven fabric.

Also, Japanese Unexamined Utility Model Publication (Kokai) No. 07-009414 describes “a multi-layer filtration cylinder” which has similar configuration as the non-woven fabric wound and laminated-type cartridge filter as described in the foregoing Japanese Kokai 01-170417. But, Kokai 07-009414 describes an organic solvent-resistant sheet as the coarse net and a glass fiber non-woven fabric adapted as the non-woven fabric layer. The glass fiber non-woven fibers are bonded to each other at their intersections by an organic solvent-resistant binder such as a phenol resin.

### SUMMARY

Conventional cylindrical filters exhibit problems in particular applications in that the particle-capture performance can be inadequate. It is also desired to provide filters to improve so-called classification filtering capacity for capturing particles with diameter equal to or larger than a predetermined dimension while passing particles with diameter less than the predetermined dimension.

It is an object of the present invention to provide a cylindrical filter having excellent particle capturing performance as well as excellent classification filtering capacity.

In order to attain above object, one aspect of the present invention provides a cylindrical filter comprising a plurality of cylindrical first filter sections having mutually different inner diameters, each first filter section including a glass fiber as a major component; a plurality of cylindrical second filter sections having mutually different inner diameters, each second filter section including a resin fiber as a major component, said second filter sections being concentrically disposed, and alternately arranged in a radial direction, relative to said first filter sections; and a pair of seal members fixedly provided on opposite axial ends of said first filter sections and said second filter sections.

### Effects of the Invention

Since the cylindrical filter according to the present invention has a configuration wherein a plurality of first filter sections each including a glass fiber as a major component and a plurality of second filter sections each including a resin fiber as a major component are concentrically disposed and alternately arranged in a radial direction relative to each other, the first and second filter sections can exhibit filtering capacity in a multilayered manner for a fluid to be filtered. As a result, a high level of particle capturing performance can be imparted to the cylindrical filter. Since each of the first filter sections and the second filter sections can be designed and formed so as to have desired filtering precision by suitable selection of materials or shaping processes, desired classification filtering capacity can be achieved by the cylindrical filter.

### BRIEF DESCRIPTION OF DRAWINGS

FIG. 1 is a perspective view showing a cylindrical filter according to a first embodiment of the present invention;

FIG. 2 is a cross sectional view of the cylindrical filter of FIG. 1, taken along line II-II;

FIG. 3 is a cross sectional view of the cylindrical filter of FIG. 1, taken along line III-III;

FIG. 4 is a cross sectional view of the cylindrical filter of FIG. 1, showing the structure of a filter body;

FIG. 5 is a perspective view showing a cylindrical filter according to a second embodiment of the present invention;

FIG. 6 is a cross sectional view of the cylindrical filter of FIG. 5, taken along line VI-VI;

FIG. 7 is a cross sectional view of the cylindrical filter of FIG. 5, taken along line VII-VII;

FIG. 8 is a perspective view, partially cut away, of the cylindrical filter of FIG. 5, showing the structure of a filter body;

FIG. 9 is a partially enlarged cross sectional view showing the structure of the filter body of the cylindrical filter of FIG. 5;

FIG. 10 is a schematic illustration showing a process of making the filter body of the cylindrical filter of FIG. 5;

FIG. 11 is a front view showing a cylindrical filter cartridge according to a third embodiment of the present invention;

FIG. 12 is a cross sectional view of the cylindrical filter of FIG. 11;

FIG. 13 illustrates particle capture performance of a cylindrical filter as shown in FIG. 1; and

FIG. 14 illustrates particle capture performance of a cylindrical filter as shown in FIG. 5.

### DETAILED DESCRIPTION

The embodiments of the present invention will be described in detail with reference to appended drawings. Throughout the drawings, corresponding components are denoted by common reference numerals.

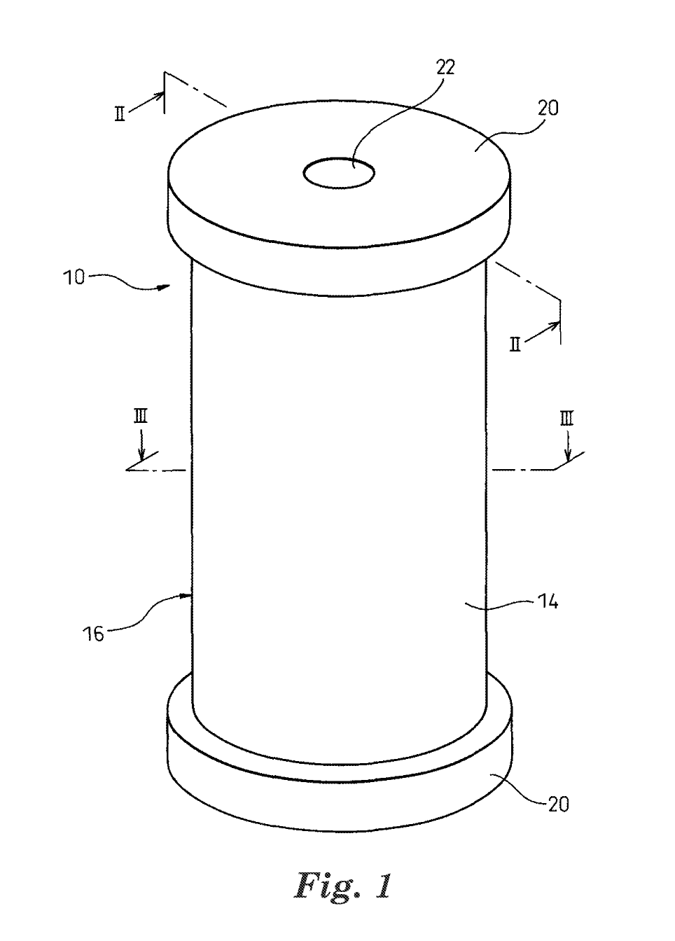

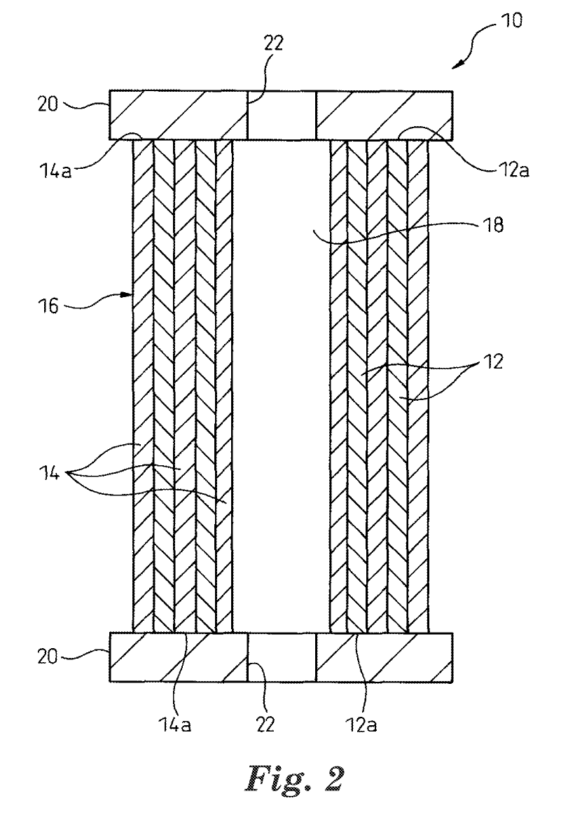

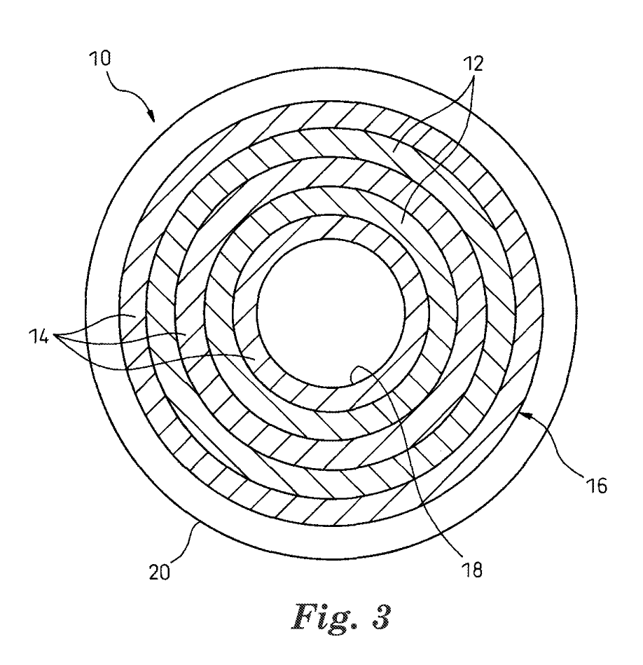

Referring to the drawings, FIG. 1 is a perspective view schematically showing a cylindrical filter 10 according to a first embodiment of the present invention, and FIG. 2 and FIG. 3 are sectional views of the cylindrical filter 10.

The cylindrical filter 10 includes a hollow cylindrical or tubular filter body 16 configured by suitably combining a plurality (two, in the drawing) of cylindrical first filter sections 12 having different inner diameters, each first filter section 12 including a glass fiber as a major component, and a plurality (three, in the drawing) of cylindrical second filter sections 14 having different inner diameters, each second filter section 14 including a resin fiber as a major component. A hollow portion 18 is formed at the center of the filter body 16 so as to penetrate therethrough in an axial direction.

The first filter sections 12 and the second filter sections 14 are disposed in a concentrically superimposed manner and alternately arranged in a radial direction relative to each other. In the illustrated embodiment, one second filter section 14 having a largest inner diameter is disposed at the outermost periphery of the filter body 16, another second filter section 14 having a smallest inner diameter is disposed at the innermost periphery of the filter body 16, and a still further second filter section 14 having a middle inner diameter is disposed at an intermediate of the filter body 16. One first filter section 12 having a larger diameter is held between the outermost second filter section 14 and the intermediate second filter section 14, while another first filter section 12 having a smaller diameter is held between the innermost second filter section 14 and the intermediate second filter section 14.

The cylindrical filter 10 further includes a pair of seal members 20 fixedly provided on the opposite axial ends 12a, 14a of the first and second filter sections 12, 14 (i.e., at the opposite axial ends of the filter body 16). Each of the seal members 20 is a plate-like member having a central opening 22 therein, and is fixed to each axial end 12a, 14a of the first and second filter sections 12, 14 by means of adhesive, thermal welding, etc. The central opening 22 of seal member 20 may have a diameter somewhat smaller than that of the hollow portion 18 of the filter body 16, and the seal member 20 may have an outer diameter somewhat larger than the outer diameter of the filter body 16. The seal member 20 is fixed to the filter body 16 with the central opening 22 coaxially aligned with the hollow portion 18. In this state, the outer peripheral region of the seal member 20 may project outward from the outer circumference of the filter body 16, as shown in the drawing. In other embodiments, seal member 20 may not project outward from filter body 16.

Cylindrical filter 10 has a coreless configuration as described above, and is a so-called cartridge type filter intended to be placed in a separate housing (not shown) when used. A cartridge type filter has, in general, a configuration that permits the filter to be removed from the housing and replaced with a new filter in the event of clogging, etc. Thus, the above-described or illustrated shape and dimensional relationship of the cylindrical filter 10 is intended to be illustrative only, and can be appropriately modified depending on the desired application of the cylindrical filter 10 (e.g., depending on the shape of the housing). The term “cylinder” or “cylindrical” as used herein includes the shape of a circular cylinder as illustrated as well as a polygonal cylinder.

When the cylindrical filter 10 is placed in the housing (not shown) for use, the filter 10 is fixed at a predetermined position in the housing by closely fitting a positioning and fixing protrusion provided within the housing into the central opening 22 of one of the seal members 20. In this state, the outer circumferential surface (in the drawing, the outer circumferential surface of the second filter section 14 having the largest inner diameter) is disposed so as to be exposed to the inner space of the housing at a fluid inlet side (so-called a primary side), and the inner circumferential surface of the filter body 16 (in the drawing, the inner circumferential surface of the second filter section 14 having the smallest inner diameter) is disposed via the central opening 22 of the other seal member 20 at a fluid outlet side (so-called a secondary side).

Thus, in the cylindrical filter 10, a fluid to be filtered flows from the outer circumferential surface of the filter body 16 to pass through the first and second filter sections 12, 14 into the hollow portion 18 of the filter body 16. During this flow, unwanted and oversized particles are removed from the fluid in accordance with the filtering precision of the first and second filter sections 12, 14. A pair of seal members 20 tightly seal the opposite axial ends of the first and second filter sections 12, 14, so that an entire volume of fluid being filtered must pass through the first and second filter sections 12, 14.

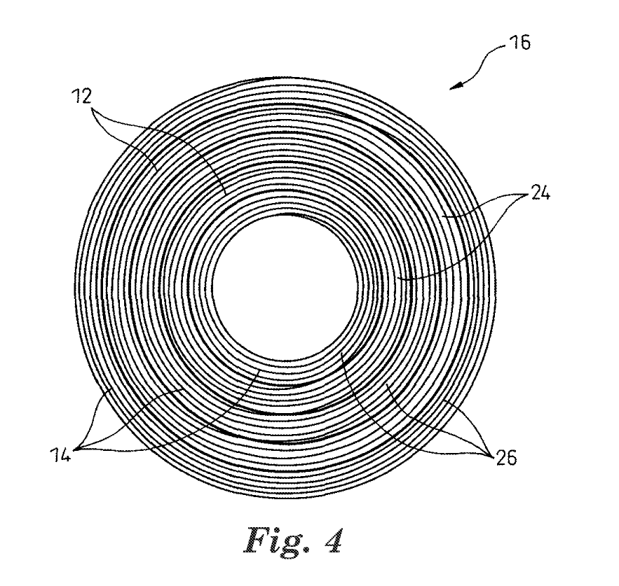

As shown in FIG. 4, in the filter body 16, each of the first filter sections 12 is formed by winding a first filter medium sheet 24 containing glass fiber by at least one-ply in a cylindrical form, and each of the second filter sections 14 is formed by winding a second filter medium sheet 26 containing a resin fiber by at least one-ply in a cylindrical form. The filter body 16 having such a configuration can be made by initially winding, in a predetermined order, a plurality of first filter medium sheets 24, previously cut into specified width and length, and a plurality of second filter medium sheets 26, previously cut into specified width and length around a shaping core (not shown). Alternatively, the filter body 16 can also be made by continuously winding a long continuous second filter medium sheet 26 having a specified width around the shaping core and by inserting the first filter medium sheets 24 having specified width and length at predetermined winding positions of the second filter medium sheet 26 between an inner ply and an outer ply. According to the latter process, the long second filter medium sheet 26 is partially interposed between adjacent plies of the first filter medium sheet 24 constituting the first filter sections 12. In either process, the first filter medium sheet 24 and the second filter medium sheet 26 have the same width.

The first filter medium sheet 24 constituting the first filter section 12 may be formed from a glass fiber non-woven fabric having mean flow pore size (MFP) measured pursuant to a specified method (ASTM F316-86), which is, for example, not less than 1 μm and not greater than 35 μm, or not less than 2 μm and not greater than 20 μm. The first filter medium sheet 24 may also be formed from a glass fiber non-woven fabric having mean thickness of, for example, not less than 0.5 mm and not greater than 1.2 mm when subjected to a pressure of 55 kPa applied in a thickness direction. The winding number of the first filter medium sheet 24 in each first filter section 12 may be, for example, not less than 1 and not more than 10. For example, each first filter section 12 may be configured from six-plies of wound first filter medium sheets 24, which are formed by winding, three times, double-layered first filter medium sheets 24 that have been prepared in advance of winding. Provided that the number of the first filter sections 12 in the filter body 16 is not less than two, the aforementioned parameters of the first filter medium sheet 24 may be suitably set depending on the shape or dimension of the cylindrical filter 10, and on the required particle capturing performance and classification filtering capacity of the cylindrical filter 10.

In some embodiments, the glass fiber non-woven fabric used for the first filter medium sheet 24 does not contain a thermosetting resin binder. In such case, each of the first filter sections 12 will typically not contain a thermosetting resin binder. In embodiments where glass fibers are partially bonded to each other with a binder, loss of flow rate and increasing pressure can occur with fluid passing through the first filter medium sheet 24. Further, substances may be generated from the binder and may exert influence on the characteristics of a fluid to be filtered.

The second filter medium sheet 26 constituting the second filter sections 14 may be formed from a non-woven fabric that, for example, contains a heat-fusible or bondable composite resin fiber, i.e., a so-called core/sheath type or parallel type composite resin fiber, in which a first fiber material that can maintain a fibrous state without causing thermal welding or thermal deformation when subjected to a sheet forming temperature, is adhered to a second fiber material that causes thermal welding or thermal deformation when subjected to the sheet forming temperature. In this case, each of the second filter sections 14 contains the heat-fusible composite resin fiber configured by combining fiber materials having different thermal properties. The winding number of the second filter medium sheet 26 in each second filter section 14 may be, for example, not less than 1 and not more than 10, and the thickness of the second filter section 14 thus formed may be, for example, at least 1 mm.

Exemplary materials usable for the heat-fusible composite resin fiber of the second filter section 14 include (1) thermoplastic resin materials, such as polyolefins such as polypropylene, polyethylene, etc., thermoplastic polyamides such as Nylon®, polyester, polyethersulfone, acryl, polystyrene, polyphenylene sulfide, fluororesin, thermoplastic polyurethane resin, ethylene-vinylacetate copolymer resin, polyacrylonitrile, etc., (2) thermosetting resin materials, such as polyurethane, etc., (3) natural occurring materials or semi-synthetic materials, such as Rayon, Acetate, wood pulp, cellulose, etc. The heat-fusible composite resin fiber non-woven fabric can be made by suitably selecting the combination of first and second fiber materials from the aforementioned materials in accordance with the application of the cylindrical filter 10, and by forming a core-sheath type or parallel type composite fiber having the first and second fiber materials adhered to each other.

The filter body 16 having the configuration as described above is formed by winding the second filter medium sheet 26 of the heat-fusible composite resin fiber into a cylindrical form while subjecting it to a sheet forming temperature determined by the materials thereof and to a predetermined pressure, so that the adjacent plies of the second filter medium sheet 26 are adhered to each other by heat-fusion bonding, which can achieve required rigidity of the filter body 16. Thus, the shaping core used for shaping the filter body 16 can be removed after the filter body 16 has been completely shaped. Since the mean flow pore or mean thickness of the second filter medium sheet 26 having such characteristics may change due to heating to the sheet forming temperature, it is desired that the materials, dimensions, etc., of the second filter medium sheet 26 should be selected while considering the filtering precision of the second filter section expected after the shaping. Even when the second fiber material of the second filter medium sheet 26 is thermally welded, mutually superimposed first and second filter medium sheets 24, 26 are not bonded by heat-fusion but maintain a contact state between the glass fiber and the resin fiber.

The seal member 20 may be formed from various materials as long as it can exhibit required sealing capability on the opposite axial ends of the filter body 16. In particular, in the case where the seal member 20 is fixed to the filter body 16 by thermal welding, the seal member 20 may be formed from thermoplastic materials, such as polyethylene foam, polypropylene, etc. In this configuration, the seal members 20 can be thermally welded to the filter body 16 by abutting the seal members 20 in a proper relative arrangement to the respective axial ends of the filter body 16 after shaping, and locally heating the contact region between filter body 16 and seal members 20 to a suitable temperature. In this case, a fixing force obtained by the thermal welding of the seal member 20 to the filter body 16 is such that a fixing force in relation to the second filter section 14 is significantly higher than a fixing force in relation to the first filter section 12. Therefore, mainly due to the fixing force in relation to the second filter section 14, the seal members 20 remain closely contact with and securely fixed to the filter body 16 against shock, such as vibrations, fluid pressure change, etc.

Because the cylindrical filter 10 having the configuration as described above includes a plurality of first filter sections 12 each having a glass fiber as a major component and a plurality of second filter sections 14 each having a resin fiber as a major component, and the first and second filter sections 12, 14 are concentrically disposed and alternately arranged in a radial direction, the first and second filter sections 12, 14 can exhibit filtering capacity in a multilayered manner for a fluid to be filtered. As a result, excellent particle capturing performance can be imparted at high level to the cylindrical filter 10. Since each of the first filter sections 12 and the second filter sections 14 can be formed so as to have desired filtering precision by suitable selection of materials or shaping processes, desired classification filtering capacity of the cylindrical filter 10 can be achieved. Further, a plurality of first filter sections 12 each having a glass fiber as a major component and each capable of being formed to have higher filtering precision than each second filter section 14 having a resin fiber as a major component, can be designed such that the filtering precisions thereof increase stepwise from the outer circumferential side (or the primary side) toward the inner circumferential side (or the secondary side) of the filter body 16 (i.e., the captured particle diameters thereof decrease stepwise from the primary side to the secondary side), and useful filter life of the cylindrical filter 10 can be thereby extended.

In particular, in the configuration in which the seal members 20 are fixed to the filter body 16 by thermal welding, the thermal welding portions of the seal members 20 to the first filter sections 12 having a glass fiber as a major component is likely to be weaker and more susceptible to damages due to shocks, such as vibrations or fluid pressure change, as compared to the thermal welding portions of the seal members 20 to the second filter sections 14 having a resin fiber as a major component. As will be discussed later, it has been confirmed that this tendency becomes more pronounced as the thickness of the first filter section 12 increases, which in turn may promise the improvement of the particle capturing performance of the single first filter section 12. In order to solve this problem, in the cylindrical filter 10 having the configuration as described above, instead of increasing one first filter section 12, a plurality of first filter sections are provided and the second filter sections 14 are interposed therebetween, so that it is possible to increase the life of the thermal welding portion between the respective first filter sections 12 and the seal members 20, and as a result, to improve the particle capturing performance of the cylindrical filter 10.

Because the second filter sections 14 are disposed respectively at the outermost and innermost peripheries of the filter body 16, it is possible to protect the first filter section 12 having, as a major component, a glass fiber that is relatively weak against shock, vibration or fluid pressure changes. The use of a resin fiber as a major component of second filter sections 14 provides protection against shock. In other words, when the cylindrical filter 10 is subjected to shock, such as vibration or fluid pressure change, the second filter sections 14 on the opposite sides of the first filter section 12 can absorb the shock and effectively prevent serious damage to the first filter sections 12. Further, the second filter section 14 disposed at the outermost periphery of the filter body 16 functions as a pre-filtration layer to the first filter section 12, while the second filter section 14 disposed at the innermost periphery of the filter body 16 also serves to capture fragments of glass fiber that have been shed from the first filter sections 12.

According to the configuration wherein the first filter section 12 is formed from at least one-ply of the first filter medium sheet 24 and the second filter section 14 is formed from at least one-ply of the second filter medium sheet 26, and wherein the second filter medium sheet 26 is partially interposed between adjacent plies of the first filter medium sheet 24, the filter body 16 can be advantageously formed by a relatively simple and continuous operation such that a long second filter medium sheet 26 is continuously wound on a shaping core and the first filter medium sheet 24 is inserted at predetermined winding positions of the second filter medium sheet 26. The heat-fusion bonding step in which the second filter medium sheet 26 composed of heat-fusible composite resin fiber non-woven fabric is heated under suitable pressure can also be performed relatively easily, as will be understood by those of ordinary skill in the art.

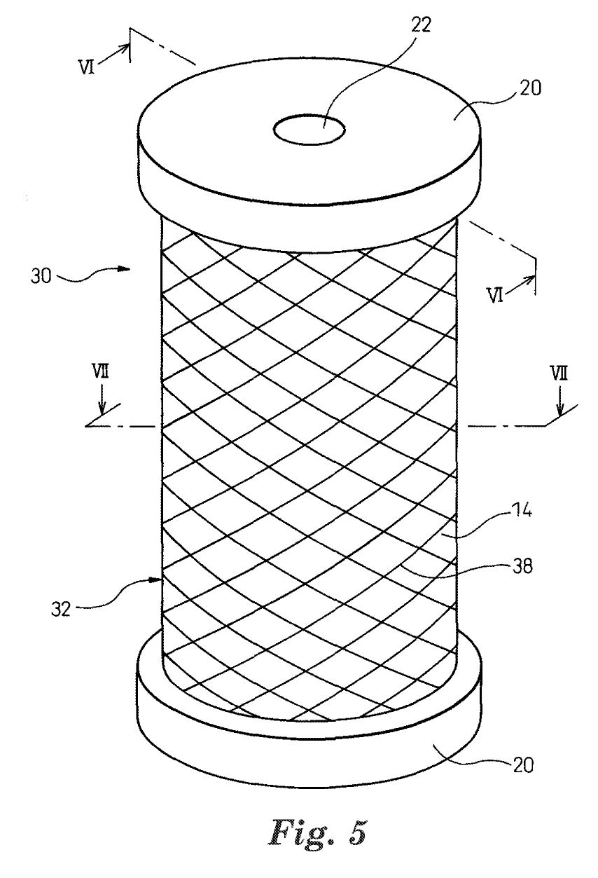

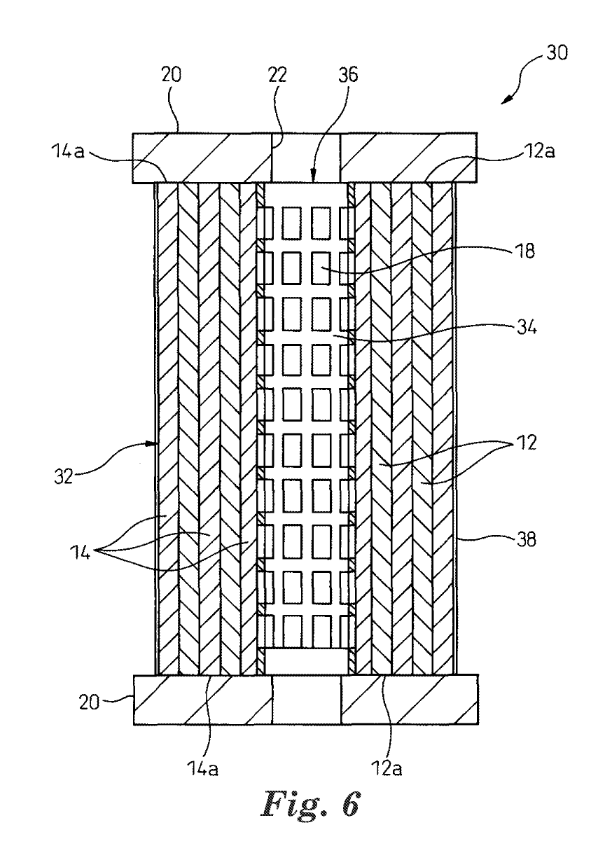

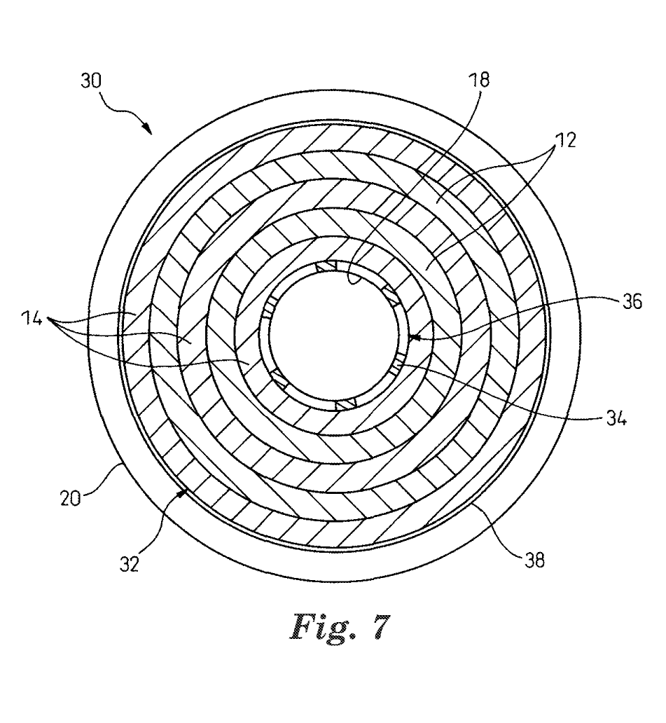

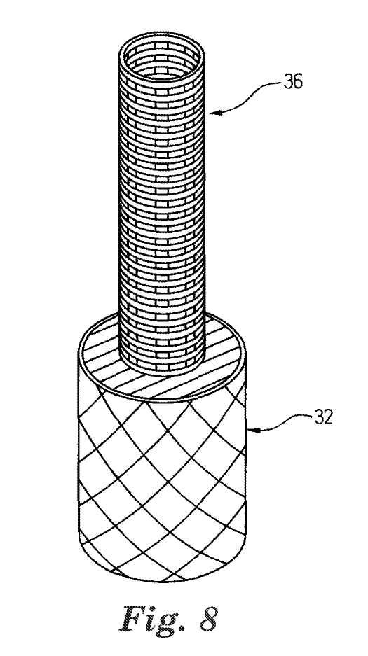

FIGS. 5 to 7 schematically show a cylindrical filter 30 according to a second embodiment of the present invention. The cylindrical filter 30 has substantially the same configuration as the cylindrical filter 10 described above, except that it has a cored configuration formed by winding a general non-woven filter medium, not containing a heat-fusible composite resin fiber, onto a core having cylindrical perforated wall. Therefore, components corresponding to those of the cylindrical filter 10 are denoted by common reference numerals, and the explanation thereof is suitably omitted.

The cylindrical filter 30 includes a hollow cylindrical or tubular filter body 32 configured by suitably combining a plurality (two, in the drawing) of cylindrical first filter sections 12 having mutually different inner diameters, each first filter section 12 including a glass fiber as a major component, and a plurality (three, in the drawing) of cylindrical second filter sections 14 having mutually different diameters, each second filter section 14 including a resin fiber as a major component. A perforated core member 36 having a perforated cylindrical wall 34 is provided at the center of the filter body 32, and a hollow portion 18 is formed inside the perforated core member 36 so as to axially penetrate therethrough.

First filter sections 12 and second filter sections 14 are disposed in a concentrically superimposed manner and are alternately arranged in a radial direction relative to each other. In the illustrated embodiment, one second filter section 14 having a largest inner diameter is disposed at the outermost periphery of the filter body 32, another second filter section 14 having a smallest inner diameter is disposed at the innermost periphery of the filter body 32, and a still further second filter section 14 having a middle inner diameter is disposed at an intermediate of the filter body 32. One first filter section 12 having a larger diameter is held between the outermost second filter section 14 and the intermediate second filter section 14, while another first filter section 12 having a smaller diameter is held between the innermost second filter section 14 and the intermediate second filter section 14.

The cylindrical filter 30 further includes a pair of seal members 20 fixedly provided on the opposite axial ends 12a, 14a of the first and second filter sections 12, 14 (i.e., at the opposite axial ends of the filter body 32). Each of the seal members 20 is a plate-like member having a central opening 22, and is fixed to each axial end 12a, 14a of the first and second filter sections 12, 14 by means of adhesive, thermal welding, etc.

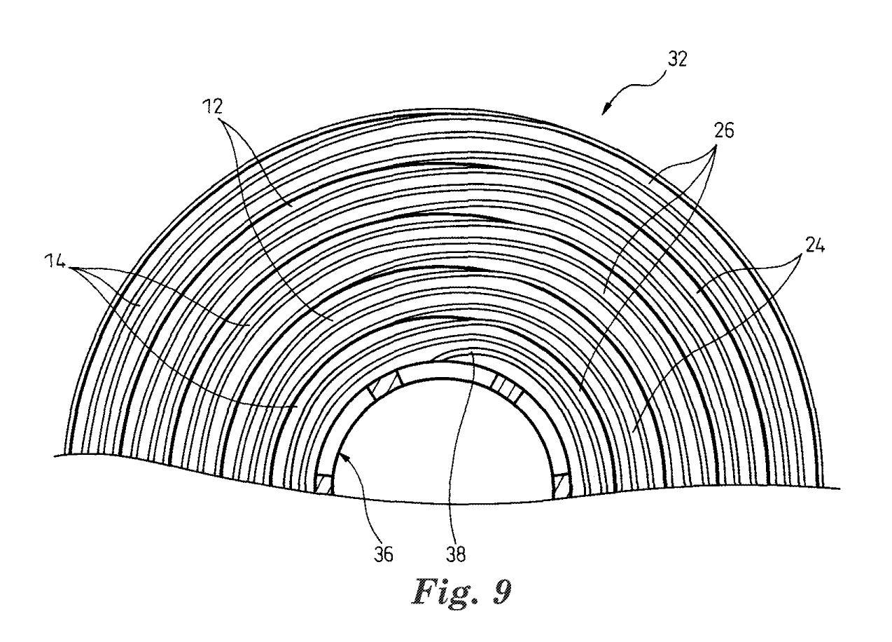

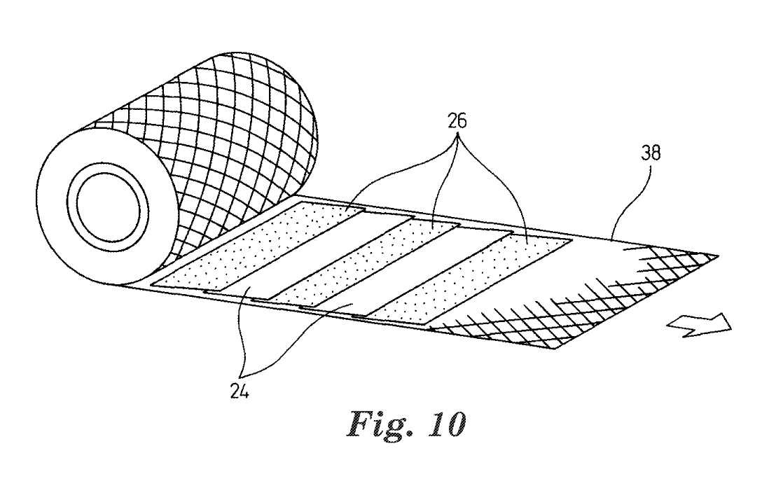

As shown in FIG. 9, in the filter body 32, each of the first filter sections 12 is formed by winding a first filter medium sheet 24 containing the glass fiber by at least one-ply in a cylindrical form, and each of the second filter sections 14 is formed by winding a second filter medium sheet 26 containing the resin fiber by at least one-ply in a cylindrical form. In this connection, as shown in FIG. 10, the filter body 32 may be made by providing a long continuous mesh-like reinforcing material 38 having a predetermined width, placing several first filter medium sheets 24 and several second filter medium sheets 26, each having a predetermined width and a predetermined length, side-by-side in a predetermined order on the reinforcing material 38, and winding continuously the reinforcing material 38 on the perforated core member 36 while successively winding therein the first filter medium sheets 24 and the second filter medium sheets 26. According to this process, the reinforcing material 38 mechanically supporting the first filter medium sheet 24 is interposed between adjacent plies of the first filter medium sheet 24 constituting the first filter sections 12, and the reinforcing material 38 mechanically supporting the second filter medium sheet 26 is interposed between adjacent plies of the second filter medium sheet 26 constituting the second filter sections 14.

In the making process shown in FIG. 10, mutually adjoining first and second filter medium sheets 24, 26 may overlap with each other as illustrated, or alternatively, may be spaced from each other. The above-described making process of the filter body 32 may be suitably modified so as to use the reinforcing material 38 for either one of the first filter medium sheet 24 and the second filter medium sheet 26. Alternatively, the filter body 32 may be made, without using the reinforcing material 38, in the same manner as described for the filter body 16 of the cylindrical filter 10.

The first filter medium sheet 24 constituting the first filter section 12 has the same configuration as the first filter medium sheet 24 used in the cylindrical filter 10, and may be formed from a glass fiber non-woven fabric having aforementioned various parameters. On the other hand, the second filter medium sheet 26 constituting the second filter section 14 may be formed from a resin fiber non-woven fabric containing a fiber, in place of the heat-fusible composite resin fiber, made of a material suitably selected from (1) thermoplastic resin materials, such as polyolefins such as polypropylene, polyethylene, etc., thermoplastic polyamides such as Nylon®, polyester, polyethersulfone, acryl, polystyrene, polyphenylene sulfide, fluororesin, thermoplastic polyurethane resin, ethylene-vinylacetate copolymer resin, polyacrylonitrile, etc., (2) thermosetting resin materials, such as polyurethane, etc., (3) natural occurring materials or semi-synthetic materials, such as Rayon, Acetate, wood pulp, cellulose, etc. Two or more materials selected from the above-described materials may be mixed into the resin fiber non-woven fabric.

The second filter medium sheet 26 may be formed from a resin fiber non-woven fabric having air permeability per unit area of, for example, not less than 3 CFM/ft² and not more than 600 CFM/ft², or, for example, not less than 5 CFM/ft² and not more than 420 CFM/ft². The second filter medium sheet 26 may be formed from a resin fiber non-woven fabric having mean thickness of, for example, not less than 0.3 mm when subjected to a pressure of 55 kPa applied in a thickness direction.

The seal member 20 may be formed from the same material as the seal member 20 of the cylindrical filter 10. In particular, in the configuration in which the seal member 20 is fixed to the filter body 32 by thermal welding, a fixing force obtained by the thermal welding of the seal member 20 to the filter body 32 is such that a fixing force in relation to the second filter section 14 is significantly higher than a fixing force in relation to the first filter section 12, as in the seal member 20 of the cylindrical filter 10. Therefore, mainly due to the fixing force in relation to the second filter section 14, the seal members 20 remain closely contact with and securely fixed to the filter body 32 against shock, such as vibrations, fluid pressure change, etc.

The perforated core member 36 may be formed from the same material as the material of the second filter medium sheet 26 constituting the second filter section 14. Alternatively, the perforated core member 36 may be formed from metal, such as copper, iron, nickel, stainless steel, aluminum, etc. In either material, it is desirable that the perforated core member 36 has sufficient rigidity so as not to be easily deformed under a pressure applied during the winding of the first and second filter medium sheets 24, 26 together with the reinforcing material 38. It is also desirable that the size, shape, number, etc., of the pores of the perforated cylindrical wall be selected such that there is no influence on the filtering capacity of the filter body 32 (i.e., loss of flow rate and pressure of a fluid to be filtered does not occur).

The reinforcing material 38 may be formed from the same material as the material for the second filter medium sheet 26 constituting the second filter section 14. Alternatively, the reinforcing material 38 may be formed from an aramide fiber known as Kevlar® or Nomex®. In either material, the reinforcing material 38 may be formed as a woven fabric having meshed structure, and it is desirable that opening area and opening ratio be selected such that there is no influence on the filtering capacity of the filter body 32 (i.e., loss of flow rate and pressure of a fluid to be filtered does not occur). A meshed structure having opening ratio of, for example, not less than 2 mesh/inch and not more than 30 mesh/inch may be adopted. In the filter body 32 in which a material, such as a heat-fusible composite fiber non-woven fabric, capable of ensuring sufficient rigidity due to self-bonding after shaping, is not used, it is required that the first and second filter medium sheets 24, 26 should be wound tightly around the perforated core 36, in order to prevent deformation of the filter body 32 caused due to a pressure of a fluid to be filtered during a filtering operation as far as possible. Therefore, it is desirable that the reinforcing material 38 has sufficient tensile strength for preventing it from being easily broken under the tension applied during a winding operation.

The cylindrical filter 30 having the configuration as described above can obtain the same effects as those of the cylindrical filter 10, such that particle capturing performance and classification filtering capacity can be improved, through substantially the same mechanism as the cylindrical filter 10. According to the configuration in which the reinforcing material 38 is interposed between adjacent plies of the first and second filter medium sheets 24, 26, the filter body 32 can be advantageously formed by a relatively simple and continuous operation such that a long reinforcing material 38 is continuously wound on the perforated core member 36 while successively winding therein the first and second filter medium sheets 24, 24. The particle capturing performance and classification filtering capacity of the cylindrical filter 30 will be discussed in further detail later.

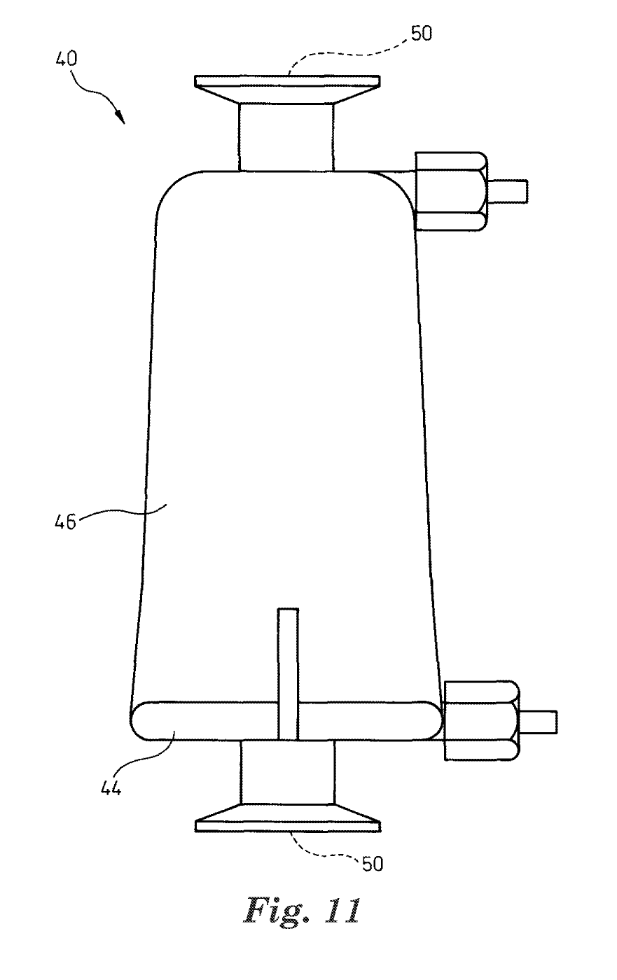

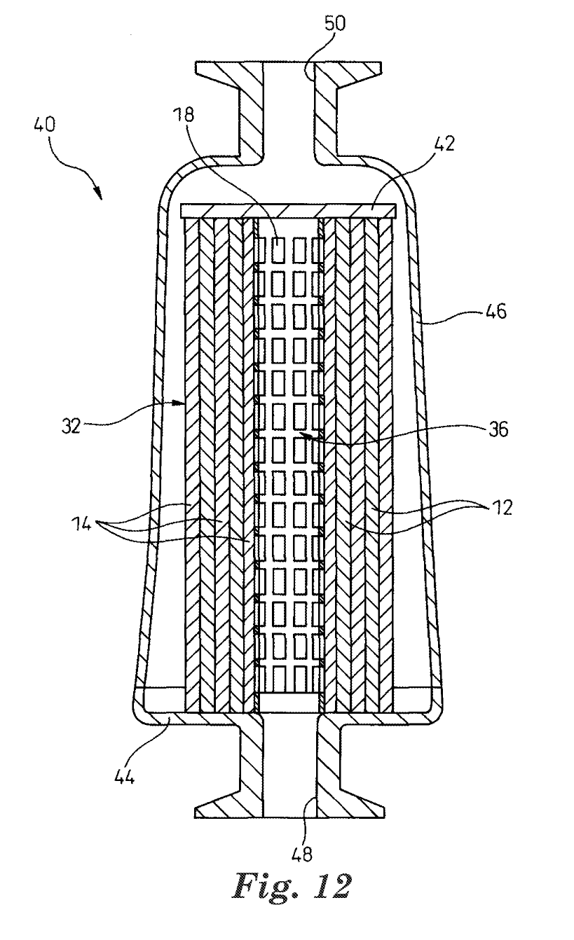

FIGS. 11 and 12 schematically show a cylindrical filter 40 according to a third embodiment of the present invention. The cylindrical filter 40 has substantially the same configuration as the cylindrical filter 30 described above, except that it is not a cartridge type filter accommodated in a separate housing for use, but a so-called capsule type filter provided integrally with a unitary molded case. Therefore, components corresponding to those of the cylindrical filter 30 are denoted by common reference numerals, and the explanation thereof will be suitably omitted. In general, a capsule type filter has a configuration permitting it to be entirely replaced with a new one in the event of clogging, etc.

The cylindrical filter 40 includes a hollow cylindrical or tubular filter body 32 configured by suitably combining a plurality (two, in the drawing) of cylindrical first filter sections 12 having mutually different inner diameters, each first filter section 12 including a glass fiber as a major component, a plurality (three, in the drawing) of cylindrical second filter sections 14 having mutually different diameters, each second filter section 14 including a resin fiber as a major component, and a perforated core member 36 provided at the center of the filter body 32. Although not shown, the filter body 32 may be made, in the same manner as the filter body 32 of the cylindrical filter 30, by winding continuously a reinforcing material 38 on the perforated core member 36 while successively winding therein the first and second filter medium sheets 24, 26.

The cylindrical filter 40 further includes a seal member 42 fixedly provided on one axial end (a top end, in the drawing) of the first and second filter sections 12, 14, a secondary side case member 44 fixedly provided on the other axial end (a bottom end, in the drawing) of the first and second filter sections 12, 14, and a primary side case member 46 accommodating the filter body 32 and fixed to the secondary side case member 44. The seal member 42 is a plate-like member having no central opening, and is fixed to one axial end of the first and second filter sections 12, 14 by means of adhesive, thermal welding, etc. The secondary side case member 44 is a lid-like member having an outlet port 48 for a fluid to be filtered, and is fixed to the other axial end of the first and second filter sections 12, 14 by means of adhesive, thermal welding, etc. The primary side case member 46 is a cup-like member having an inlet port 50 for a fluid to be filtered, and is fixed to the secondary side case member 44 by means of adhesive, thermal welding, etc.

In the cylindrical filter 40, a fluid to be filtered is introduced through the inlet port 50 into a space between the primary side case member 44 and the filter body 32, flows from the outer circumferential surface of the filter body 32 to pass through the first and second filter sections 12, 14 into the hollow portion 18 of the filter body 32, and discharged through the outlet port 48 of the secondary side case member 44 to the outside. The seal member 42 and the secondary side case member 44 tightly seal the opposite axial ends of the first and second filter sections 12, 14, so that entire fluid surely passes through the first and second filter sections 12, 14.

The cylindrical filter 40 having the configuration as described above can obtain the same effects as those of the cylindrical filter 10, such that particle capturing performance and classification filtering capacity can be improved, through substantially the same mechanism as the cylindrical filter 10.

The cylindrical filter according to the present invention (e.g., cylindrical filter 10, 30, 40) may be used in an application for precision filtration requiring that particles having dimensions not less than 0.1 μm and not greater than 10 μm are captured. An exemplary precision filtration application is a preparation of CMP (Chemical Mechanical Planarization) slurry used for surface polishing in a semiconductor manufacturing process. CMP slurry is a polishing liquid in which particles such as colloidal silica, fumed silica, cerium oxide, etc., are dispersed in a chemical solution, and has a mechanical polishing function by the fine particles and a chemical polishing function by the chemical solution. If nonstandard oversize particles exist in the solution, the surface of a wafer may be damaged during polishing of the wafer. Therefore, in the preparation process of CMP slurry, it is required to use a high performance filter having particle capturing performance for surely removing the oversize particles and classification filtering capacity for leaving sufficient particles necessary for polishing in the chemical solution, and the requirement has recently risen to a high level. The cylindrical filter according to the present invention (e.g., cylindrical filter 10, 30, 40) can meet such a requirement. The cylindrical filter according to the present invention may be used for other applications, such as filtration of color resist, ink, beverage, or food processing, etc.

### EXAMPLES

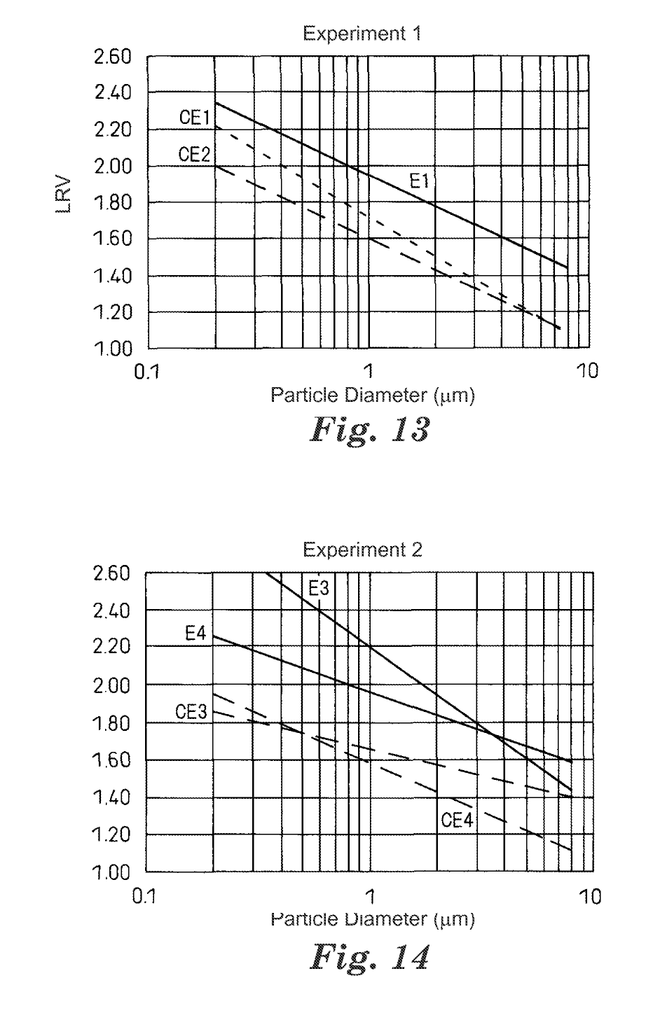

In order to further clarify the effect of the cylindrical filter according to the present invention, the contents and results of experiments carried out by the inventors will be described below with reference to FIGS. 13 and 14.

### Experiment 1

As Example 1 (E1), a cylindrical filter 10 according to the first embodiment was provided to have the following configuration. A master filter body was made by continuously winding a second filter medium sheet 26, formed from a core-sheath type heat-fusible composite resin fiber containing a first fiber material made of polypropylene and a second fiber material made of polyethylene, onto a shaping core while subjecting the second filter medium sheet to heat and tension, inserting first filter medium sheets 24 having predetermined size (each being formed by superimposing two sheet parts, each having MFP of 3.0 μm and mean thickness of 0.63 mm, so as to obtain thickness of about 1.26 mm) was inserted between an inner ply and an outer ply at respective two spaced winding positions of the second filter medium sheet 26, and thereafter detaching the shaping core. The master filter body was cut into a length of about 5 cm so as to make a filter body 16, and seal members 20 made of polypropylene were fixed to the opposite axial ends of the filter body 16 by thermal welding so as to obtain the cylindrical filter 10. The winding number of the first filter medium sheet 24 in the inner first filter section 12 with small diameter was about 8, and the winding number of the first filter medium sheet 24 in the outer first filter section 12 with large diameter was about 6. The thickness of the second filter section 14 between the first filter sections 12 was 4.0 mm, and the filter body 16 had an inner diameter of 27 mm and an outer diameter of 64 mm.

As Comparative Example 1 (CE1), a cylindrical filter, of which a filter body includes only one first filter section having the same configuration as the first filter section 12 in Example 1, was provided. The winding number of the first filter medium sheet in the first filter section was about 7.

As Comparative Example 2 (CE2), a cylindrical filter, of which a filter body includes only one first filter section different only in thickness from the first filter section 12 in Example 1, was provided. The thickness of the first filter medium sheet in the first filter section was about 2.52 mm obtained by using four sheet parts, and the winding number thereof was about 14.

As Example 2, a cylindrical filter 10 having substantially the same configuration as Example 1, except that a first filter medium sheet 24 has a configuration different from the first filter medium sheet 24 in Example 1, was provided. The first filter medium sheet 24 of Example 2 was formed by superimposing two sheet parts, each having MFP of 2.0 μm and mean thickness of 0.76 mm, so as to obtain thickness of about 1.52 mm. The winding number of the first filter medium sheet 24 in the inner first filter section 12 with small diameter was about 4.5, and the winding number of the first filter medium sheet 24 in the outer first filter section 12 with large diameter was about 3.5.

With respect to Examples 1 and 2 and Comparative Examples 1 and 2, particle capturing performance and classification filtering capacity of each cylindrical filter were verified through the following process. A sample liquid prepared by dispersing fumed silica having MFP (D50) of 0.2 μm-0.4 μm in tap water (0.1 μm filtered water, 25° C.) with concentrations of 100 ppm/water, is passed through the cylindrical filter at flow rate of 100 mL/min for 3 minutes, and then the liquid after filtration was picked. Particle capturing performance was verified by using particle removal performance (LRV: Log Reduction Value) obtained by counting the number of particles contained in the sample liquid before and after filtration for each particle size. Result of the verification is shown in FIG. 13.

As can be seen from FIG. 13, the cylindrical filter 10 of E1 exhibits higher particle capturing performance in all particle sizes than the cylindrical filter of CE1 including only one first filter section. On the other hand, the particle capturing performance of the cylindrical filter of CE2 including the first filter section having doubled thickness was lower than that of the cylindrical filter CE1. Thus, it was proved that the particle capturing performance of the cylindrical filter 10 was improved by adopting the configuration in which the several first filter sections are provided and the second filter section is interposed between the first filter sections, instead of simply increasing the thickness of the single first filter section. Regarding the cylindrical filter of E2, the material of the first filter medium sheet 24 thereof is different from that of the cylindrical filter E1, CE1, CE2, and therefore, E2 is not shown in FIG. 13. However, it was confirmed that the cylindrical filter E2 had particle capturing performance comparable to that of the cylindrical filter E1. With respect to the classification filtering capacity for leaving required particles, significant difference was not substantially found among the cylindrical filters E1, E2, CE1 and CE2, and it was confirmed that they exhibited required level of the classification filtering capacity.

### Experiment 2

As Example 3 (E3), a cylindrical filter 30 according to the second embodiment was provided to have the following configuration. A master filter body was made by thermally welding a leading end of a reinforcing material 38 (opening ratio of 12 mesh/inch, thickness of 0.8 mm) made of polypropylene was thermally welded to a perforated core member 36 (inner diameter of 28 mm, outer diameter of 33 mm) made of polypropylene; placing [A] a second filter medium sheet 26 formed from a polypropylene non-woven fabric (formed by superimposing two sheet parts, each having air permeability of 150 CFM/ft² and mean thickness of 0.4 mm, so as to obtain thickness of about 0.8 mm: 40 cm length), [B] a first filter medium sheet 24 formed from a glass fiber non-woven fabric (formed by superimposing two sheet parts, each having MFP of 2.0 μm and mean thickness of 0.76 mm, so as to obtain thickness of about 1.52 mm: 30 cm length), and [C] a first filter medium sheet 24 formed from a glass fiber non-woven fabric (formed by superimposing two sheet parts, each having MFP of 3.0 μm and mean thickness of 0.63 mm, so as to obtain thickness of about 1.26 mm: 50 cm length), on a surface of the reinforcing material 38 facing toward the perforated core member 36, in the order of A-(12 cm overlap)-B-(14 cm overlap)-A(18 cm overlap)-C(20 cm overlap)-A, from the inside to the outside; winding, under tension, the reinforcing material 38 on the perforated core member 36 while successively winding therein the first and second filter medium sheets 24, 26; and thermally welding the trailing end of the reinforcing material 38. The master filter body was cut into a length of about 5 cm so as to make a filter body 32, and seal members 20 made of polypropylene were fixed to the opposite axial ends of the filter body 32 by thermal welding so as to obtain the cylindrical filter 30. The winding number of the first filter medium sheet 24 in the inner first filter section 12(B) with small diameter was about 2, and the winding number of the first filter medium sheet 24 in the outer first filter section 12(C) with large diameter was about 6. The thickness of the second filter section 14 between the first filter sections 12 was 2.4 mm, and the outer diameter of the filter body 32 was 64 mm.

As Example 4 (E4), a cylindrical filter 30 having substantially the same configuration as Example 3, except that two first filter sections 12 in Example 3 were formed from mutually identical first filter medium sheets 24 (each being formed by superimposing two sheet parts, each having MFP of 3.0 μm and mean thickness of 0.63 mm, so as to obtain thickness of about 1.26 mm), was provided. The winding number of the first filter medium sheet 24 in the inner first filter section 12 with small diameter was about 7, and the winding number of the first filter medium sheet 24 in the outer first filter section 12 with large diameter was about 6. The thickness of the second filter section 14 between the first filter sections 12 was 2.3 mm, and the outer diameter of the filter body 32 was 65 mm.

As Comparative Example 3 (CE3), a cylindrical filter, of which a filter body includes only one first filter section having the same configuration as the outer first filter section 12(C) in Example 3, was provided. The winding number of the first filter medium sheet in the first filter section was about 6.5. The outer diameter of the filter body was 63 mm.

As Comparative Example 4 (CE4), a cylindrical filter, of which a filter body includes only one first filter section having the same configuration as the inner first filter section 12(B) in Example 3, was provided. The winding number of the first filter medium sheet in the first filter section was about 3.5. The outer diameter of the filter body was 64 mm.

With respect to Examples 3 and 4 and Comparative Examples 3 and 4, particle capturing performance and classification filtering capacity were verified by passing the same sample liquid in the same condition as those in Experiment 1 through each cylindrical filter, and picking the liquid after filtration. Particle capturing performance was verified by using particle removal performance (LRV: Log Reduction Value) obtained by counting the number of particles contained in the sample liquid before and after filtration for each particle size. Result of the verification is shown in FIG. 14.

As can be seen from FIG. 14, the cylindrical filters 30 of E3 and E4 exhibit higher particle capturing performance in all particle sizes than the cylindrical filter of CE3 and CE4 including only one first filter section. With respect to the classification filtering capacity for leaving required particles, significant difference was not substantially found among the cylindrical filters E3, E4, CE3 and CE4, and it was confirmed that they exhibited required level of the classification filtering capacity.

1. A cylindrical filter comprising;
a plurality of cylindrical first filter sections having mutually different inner diameters, each first filter section including a glass fiber as a major component;
a plurality of cylindrical second filter sections having mutually different inner diameters, each second filter section including a resin fiber as a major component, said second filter sections being concentrically disposed, and alternately arranged in a radial direction, relative to said first filter sections; and
a pair of seal members fixedly provided on opposite axial ends of said first filter sections and said second filter sections.

2. The cylindrical filter of claim 1, wherein each of said first filter sections is formed by winding a first filter medium sheet containing said glass fiber by at least one-ply in a cylindrical form.

3. The cylindrical filter of claim 2, wherein a mesh-like reinforcing material mechanically supporting said first filter medium sheet is interposed between adjacent plies of said first filter medium sheet.

4. The cylindrical filter of claim 1, wherein each of said second filter sections is formed by winding a second filter medium sheet containing said resin fiber by at least one-ply in a cylindrical form.

5. The cylindrical filter of claim 4, wherein a mesh-like reinforcing material mechanically supporting said second filter medium sheet is interposed between adjacent plies of said second filter medium sheet.

6. The cylindrical filter of claim 1, further comprising a perforated core member provided at a center of a cylindrical filter body including said first filter sections and said second filter sections.

7. The cylindrical filter of claim 1, wherein each of said first filter sections is formed by winding a first filter medium sheet containing said glass fiber by at least one-ply in a cylindrical form; wherein each of said second filter sections is formed by winding a second filter medium sheet containing said resin fiber by at least one-ply in a cylindrical form; and wherein said second filter medium sheet is partially interposed between adjacent plies of said first filter medium sheet.

8. The cylindrical filter of claim 7, wherein each of said second filter sections contains a heat-fusible composite resin fiber.

9. The cylindrical filter of claim 1, wherein each of said first filter sections does not contain a thermosetting resin binder.

10. The cylindrical filter of claim 1, wherein one of said second filter sections is disposed at an outermost periphery of a cylindrical filter body including said first filter sections and said second filter sections.

11. The cylindrical filter of claim 1, wherein one of said second filter sections is disposed at an innermost periphery of a cylindrical filter body including said first filter sections and said second filter sections.

12. The cylindrical filter of claim 1, wherein said second filter sections are thermally welded with said pair of seal members.
